(19) United States
(12) Patent Application Publication
(10) Pub. No.: US 2011/0091733 A1
(43) Pub. Date: Apr. 21, 2011

(54) PAPER COATING COMPOSITION COMPRISING METAL SALT PIGMENTS AND HAVING A CONTENT OF AQUEOUS DISPERSIONS OF WATER-SOLUBLE COPOLYMERS

(75) Inventors: Robert Feuerhake, Mannheim (DE); Ilshat Gubaydullin, Ludwigshafen (DE); Werner Gauweiler, Lustadt (DE); Christina Niedberg, Ludwigshafen (DE); Hermann Seyffer, Heidelberg (DE); Volker Schaedler, Maikammer (DE)

(73) Assignee: BASF SE, Ludwigshafen (DE)

(21) Appl. No.: 12/999,096

(22) PCT Filed: Jun. 19, 2009
(86) PCT No.: PCT/EP2009/057662

§ 371 Date: Dec. 15, 2010

(30) Foreign Application Priority Data
Jun. 24, 2008 (EP) 08158872.5

(51) Int. Cl. C09D 131/04; C09D 133/08; C08K 3/30; C08K 3/26; C08K 3/22; C08K 3/34; B32B 27/10

(52) U.S. Cl. 428/514; 524/563; 524/556; 524/423; 524/424; 524/425; 524/430; 524/432; 524/447; 524/451

(57) ABSTRACT

A paper coating slip which comprises metal salt pigments in an amount of at least 40 parts by weight, based on the total amount of pigments, and an aqueous dispersion of water-soluble copolymers is described. The copolymers are obtainable by free radical polymerization of ethylenically unsaturated, anionic monomers with ethylenically unsaturated, nonionic monomers in the presence of polymeric stabilizers for water-in-water polymer dispersions. The paper coating slips have good rheological properties and good water retention behavior in the coating of paper or cardboard.

The invention relates to paper coating slips which comprise metal salt pigments, in particular carbonate pigments, and an aqueous dispersion of water-soluble copolymers. The copolymers are obtainable by free-radical polymerization of ethylenically unsaturated, anionic monomers with ethylenically unsaturated, nonionic monomers in the presence of polymeric stabilizers for water-in-water polymer dispersions. The paper coating slips have good rheological properties and good water retention behavior in the coating of paper or cardboard.

In addition to water, paper coating slips generally comprise pigments, binders and assistants for establishing the required rheological properties, e.g. thickeners. By means of paper coating slips, base papers acquire the desired mechanical and optical properties. The binder is intended for fixing the pigments on the paper and ensuring the cohesiveness in the coating obtained. The papers coated with the paper coating slips should in particular be readily printable. The paper coating slips can be applied to a continuous paper web by means of suitable rolls, it being possible to scrape off excess coating slip by means of a blade and to recirculate it to the storage container of the coating slip. For simple and problem-free processing of the aqueous paper coating slip, rheological behavior tailored to the processing method is desired. On application with low shearing, the viscosity should be as high as possible; on scraping off with high shearing, the viscosity should be as low as possible. Moreover, the rheological behavior during continuous application with recirculation of scraped-off material should remain constant for as long as possible. Through the suction effect of the paper, water is continuously withdrawn from the coating slip and undesired viscosity increases may result thereby. Coating slips which have as low a water retention as possible are therefore desired. Coating slips having as high a solids content as possible are also desired since less water is to be removed on drying and energy costs can be reduced. The thickener composition used for producing the coating slips should therefore be as highly concentrated as possible but should nevertheless initially have a low viscosity and should display its thickening effect only during use (e.g. by adjustment of the pH). Highly concentrated but nevertheless low-viscosity polymer compositions can be prepared, for example, as polymer dispersions by emulsion polymerization, but the achievable chain length of the polymers is frequently limited (particularly in the case of acrylic acid polymers) and the water retention of the paper coating slips prepared therewith is not yet completely satisfactory. By preparing aqueous dispersions of water-soluble polymers (so-called water-in-water emulsions) in the presence of suitable stabilizers, relatively long-chain polyacrylic acids can be prepared but undesired gelling may occur before or during use in the case of compositions having a high solids content, in particular by interaction with the other constituents of a paper coating slip. The water retention, too, may be adversely affected by interaction with the other constituents of a paper slip.

Aqueous dispersions of water-soluble polymers of ethylenically unsaturated anionic monomers and their use are described, inter alia, as an additive to paper coating slips in WO 2005/012378, in WO 2006/018113, in WO 2006/087344 and in WO 2006/122947. Crosslinked water-soluble polymer dispersions and the use thereof as thickeners or as a constituent of paper and wallpaper coatings are described in EP 0 761 701 A1. Water-soluble polymer dispersions and the use thereof as thickeners are also described in EP 0 664 302 A2 and in WO 03/097703. Stable water-in-water emulsions having a small particle size and the use thereof as thickeners are described in WO 99/50308. Polymer dispersions of a dispersed polymer of a water-soluble, anionic monomer in the presence of polymeric stabilizers and the use of the polymer dispersions as thickeners are described in WO 2006/123993.

It was an object of the present invention to provide paper coating slips having a good rheological use profile, low water retention and reduced tendency to gelling.

The invention relates to a paper coating slip comprising
(i) inorganic pigments, at least one metal salt pigment being present in an amount of at least 40 parts by weight, based on the total amount of pigments and
(ii) an aqueous dispersion of water-soluble copolymers obtainable by free-radical polymerization of at least one first monomer type and at least one second monomer type in the presence of at least one polymeric stabilizer for water-in-water polymer dispersions,
   the first monomer type comprising ethylenically unsaturated, anionic monomers capable of free-radical polymerization and the second monomer type comprising ethylenically unsaturated, nonionic monomers capable of free-radical polymerization.

The invention also relates to the use of the paper coating slip according to the invention for coating paper or cardboard and to paper or cardboard coated with the paper coating slip according to the invention.

Below, the designation (meth)acrylate and similar designations are used as abbreviated notation for “acrylate or methacrylate”.

### Pigments

The paper coating slip comprises pigments in an amount of preferably at least 80% by weight, e.g. from 80 to 95% by weight or from 80 to 90% by weight, based on the total solids content. The paper coating slip comprises at least one inorganic metal salt pigment. The amount of metal salt pigment is preferably at least 40% by weight or at least 50% by weight or at least 60% by weight or 100% by weight, based in each case on the total amount of pigments. In particular, white pigments are suitable. Metal salt pigments are, for example, calcium sulfate, calcium aluminate sulfate, barium sulfate, magnesium carbonate and calcium carbonate, of which carbonate pigments, in particular calcium carbonate, are preferred. The calcium carbonate may be natural ground calcium carbonate (GCC), precipitated calcium carbonate (PCC), lime or chalk. Suitable calcium carbonate pigments are available, for example, as Covercarb® 60, Hydrocarb® 60 or Hydrocarb® 90 ME.

In addition to the metal salt pigments, further pigments may be present in the paper coating slip. The additional pigments can be selected, for example, from the group consisting of silicic acids, aluminum oxides, hydrated alumina, silicates, titanium dioxide, zinc oxide, kaolin, alumina, talc and silicon dioxide. Suitable further pigments are available, for example, as Capim® MP 50 (Clay), Hydragloss® 90 (Clay) or Talcum C10.

### Aqueous Dispersion of Water-Soluble Copolymers

The paper coating slip comprises an aqueous dispersion of water-soluble copolymers. The content of copolymer in the paper coating slip is preferably from 0.05 to 5 parts by weight or from 0.07 to 2 parts by weight or from 0.1 to 1.6 parts by weight per 100 parts by weight or pigment (solid, i.e. without water or other solvents liquid at 21° C., 1 bar). Aqueous dispersions of water-soluble polymers can be prepared by water-in-water emulsion polymerization. Here, water-soluble monomers are polymerized in the presence of suitable polymeric stabilizers in an aqueous medium. The polymeric stabilizers produce incompatibilities of the resulting water-soluble polymers with the aqueous medium, which leads to the formation of a dispersed polymer phase. The copolymers are formed from at least one first monomer type and at least one second monomer type.

The first monomer type from which the copolymers are formed are ethylenically unsaturated, anionic monomers capable of free-radical polymerization. The amount of the first monomer type is preferably 60% by weight or at least 80% by weight and preferably up to 95% by weight or up to 90% by weight, based on the total amount of monomers.

Anionic monomers are those which comprise anionic groups, e.g. carboxylate groups, phosphonate groups or sulfonate groups. Carboxylate groups are preferred. The associated cation is, for example, a metal cation. The copolymer preferably comprises at least 0.01 mol or at least 0.05 mol or at least 0.1 mol of acid groups per 100 g of copolymer; the content of the acid groups is in general not greater than 1.4 mol, in particular not greater than 1.2 mol or not greater than 1 mol of acid groups/100 g of copolymer. Preferably, at least 20 mol %, particularly preferably at least 40 mol %, very particularly preferably at least 60 mol %, in a particular embodiment 100 mol %, of the acid groups are present in anionic form, i.e. as a salt. The cationic counterion to the anionic acid groups may be a monovalent or polylvalent, e.g. divalent or trivalent, counterion. Monovalent cationic counterions are preferred. For example, the cations of the alkali metals, in particular of sodium or potassium, are suitable. Nitrogen compounds, e.g. the ammonium cation and derivatives thereof, are also suitable, and the sodium and potassium cations are preferred.

Suitable ethylenically unsaturated, anionic monomers for the preparation of the aqueous copolymer dispersions are monomers having an acid group or a salt group derived therefrom. For example, monomers having an acid anhydride group which can be subsequently easily converted into acid groups and salts thereof are however also suitable; as a result, after the conversion, the latter is then also a monomer having an acid or salt group. Monomers having an acid or salt group are designated below as anionic monomers. Preferred anionic monomers are, for example, monomers having a carboxyl group, a sulfo group or a phosphonic acid group; monomers having a carboxy group are particularly preferred. Anionic monomers are, for example, monoethylenically unsaturated C₃- to C₅-carboxylic acids, such as acrylic acid, methacrylic acid, ethacrylic acid, crotonic acid, maleic acid, fumaric acid, itaconic acid and/or the alkali metal or ammonium salts of these acids. Monomers having phosphonic acid or sulfo groups are, for example, vinylphosphonic acid, vinylsulfonic acid, styrenesulfonic acid and acrylamidosulfonic acids, in particular acrylamido-2-methylpropanesulfonic acid. The preferably used anionic monomers include acrylic acid, methacrylic acid, maleic acid and acrylamido-2-methylpropanesulfonic acid. Aqueous dispersions of polymers based on acrylic acid are particularly preferred. The anionic monomers can be used either alone or as a mixture with one another. Examples of these are copolymers comprising a mixture of acrylic acid with methacrylic acid and/or maleic acid as the first monomer type.

The second monomer type from which the copolymers are formed are ethylenically unsaturated, nonionic monomers capable of free-radical polymerization. Based on the monomers used altogether in the polymerization, the amount of the second monomer type is preferably from 5 to 40% by weight or from 10 to 20% by weight, based on the total amount of monomers. The ratio of the sum of all anionic monomers of the first monomer type to the sum of all nonionic monomers of the second monomer type is preferably from 95:5 to 60:40 or from 90:10 to 80:20.

Monomers of the second monomer type are selected, for example, from C₁-C₂₀-alkyl (meth)acrylates, vinyl esters of carboxylic acids comprising up to 20 carbon atoms, vinylaromatics having up to 20 carbon atoms, vinyl halides, aliphatic hydrocarbons having 2 to 8 carbon atoms and one or two double bonds, monomers comprising ether groups, in particular vinyl ethers of alcohols comprising 1 to 10 carbon atoms (ether monomers for short) and monomers having at least one nitrogen atom in the molecule (nitrogen monomers for short) or mixtures of these monomers. Nitrogen monomers are, for example, vinylcarboxamides, (meth)acrylamide, N-vinylformamide, N-vinyl-acetamide, N-methyl-N-vinylformamide, N-methyl-N-vinylacetamide, N-vinyl-pyrrolidone, N-vinylcaprolactam, vinylimidazole. Vinylcarboxamides can eliminate carboxyl groups under hydrolysis conditions and are then present as vinylamines. Under corresponding pH conditions, amines form cationic groups. Elimination of the carboxyl groups from the vinylcarboxamides is therefore not preferred in the context of this invention. If such an elimination takes place, the number of amino groups which are cationic or can be made cationic should be smaller than the number of anionic groups, in particular less than half the number of anionic groups. It is preferable if the vinylcarboxamides are incorporated in the form of polymerized units in an amount of more than 50 mol %, in particular more than 80 mol %, very particularly preferably more than 95 mol % or 100 mol % in the polymer as vinylcarboxamides, i.e. without elimination of the carboxyl group.

Preferred monomers of the second monomer type are selected from the group consisting of acrylamide, methacrylamide, acrylates of monohydric alcohols having 1 to 20 carbon atoms, methacrylates of monohydric alcohols having 1 to 20 carbon atoms, vinyl acetate and vinyl propionate.

Preferred copolymers are copolymers of acrylic acid with at least one comonomer selected from the group consisting of acrylates of monohydric alcohols having 1 to 20 carbon atoms and methacrylates of monohydric alcohols having 1 to 20 carbon atoms.

The copolymers preferably have a K value of at least 60 or at least 100, up to 400, e.g. from 60 to 250 or from 100 to 200; determinable according to H. Fikentscher in 5% strength by weight aqueous sodium chloride solution at 25° C., a polymer concentration of 0.1% by weight and a pH of 7. From light scattering experiments, it follows that a K value of 250 corresponds to an average molecular weight of the polymers of about 7 000 000 dalton.

The polymerization can additionally be carried out in the presence of at least one crosslinking agent. Copolymers having a higher molar mass than in the case of the polymerization of the anionic monomers in the absence of a crosslinking agent are then obtained. The incorporation of a crosslinking agent into the polymers also leads to reduced solubility of the polymers in water. Depending on the amount of crosslinking agent incorporated in the form of polymerized units, the polymers are water-insoluble but are swellable in water. There are fluid transitions between complete solubility of the polymers in water and the swelling of the polymers in water. Owing to their swellability in water, crosslinked copolymers have a high water absorptivity. They can be used, for example, as thickeners for aqueous systems, such as paper coating slips.

In an embodiment of the invention, the water-soluble copolymers present in the aqueous dispersion are not crosslinked. The uncrosslinked copolymers have the advantage that they have greater efficiency in paper coating slips, particularly in a small dose.

If a crosslinking agent is nevertheless used, all compounds which have at least two ethylenically unsaturated double bonds in the molecule can be used for this purpose. Such compounds are used, for example, in the preparation of crosslinked polyacrylic acids, such as superabsorbent polymers, cf. EP-A 858 478, page 4, line 30 to page 5, line 43. Examples of crosslinking agents are triallylamine, pentaerythrityl triallyl ether, methylenebisacrylamide, N,N′-divinylethyleneurea, allyl ethers comprising at least two allyl groups or vinyl ethers having at least two vinyl groups, of polyhydric alcohols, such as, for example, sorbitol, 1,2-ethanediol, 1,4-butanediol, trimethylolpropane, glycerol, diethylene glycol, and of sugars, such as sucrose, glucose, mannose, dihydric alcohols completely esterified with acrylic acid or methacrylic acid and having 2 to 4 carbon atoms, such as ethylene glycol dimethacrylate, ethylene glycol diacrylate, butanediol dimethacrylate, butanediol diacrylate, diacrylates or dimethacrylates of polyethylene glycols having molecular weights of from 300 to 600, ethoxylated trimethylolpropane triacrylates or ethoxylated trimethylolpropane trimethacrylates, 2,2-bis(hydroxymethyl)butanol trimethacrylate, pentaerythrityl triacrylate, pentaerythrityl tetraacrylate and triallylmethylammonium chloride. If crosslinking agents are used in the preparation of the anionic dispersions, the amounts of crosslinking agent used in each case are, for example, from 0.0005 to 5.0, preferably from 0.001 to 1.0% by weight, based on the monomers used altogether in the polymerization. Preferably used crosslinking agents are pentaerythrityl triallyl ether, N,N′-divinylethyleneurea, allyl ethers comprising at least two allyl groups, of sugars such as sucrose, glucose or mannose, and triallylamine and/or ethoxylated trimethylolpropane triacrylate and mixtures of these compounds.

The polymerization can additionally be carried out in the presence of at least one chain-transfer agent. Polymers which have a lower molar mass and smaller K values than polymers prepared without chain-transfer agents are then obtained. Examples of chain-transfer agents are compounds which comprise sulfur in bound form, such as dodecyl mercaptan, thiodiglycol, ethylthioethanol, di-n-butyl sulfide, di-n-octyl sulfide, diphenyl sulfide, diisopropyl disulfide, 2-mercaptoethanol, 1,3-mercaptopropanol, 3-mercaptopropane-1,2-diol, 1,4-mercaptobutanol, thioglycolic acid, 3-mercaptopropionic acid, mercaptosuccinic acid, thioacetic acid and thioureas, aldehydes, organic acids, such as formic acid, sodium formate or ammonium formate, alcohols, such as in particular isopropanol, and phosphorus compounds, e.g. sodium hypophosphite. It is possible to use a single chain-transfer agent or a plurality of chain-transfer agents in the polymerization. If they are used in the polymerization, they are employed, for example, in an amount of from 0.01 to 5.0, preferably from 0.2 to 1, % by weight, based on the total monomers. The chain-transfer agents are preferably used together with at least one crosslinking agent of the polymerization. By varying the amount and the ratio of chain-transfer agent and crosslinking agent, it is possible to control the rheology of the polymers forming. Chain-transfer agent and/or crosslinking agent may be initially taken in the polymerization, for example in the aqueous polymerization medium, or can be metered into the polymerization batch together with or separately from the monomers according to the progress of the polymerization.

In an embodiment of the invention, the water-soluble copolymers present in the aqueous dispersion are prepared without the use of a regulator. The copolymers prepared without a regulator and having higher K values (e.g. greater than 100) have the advantage that they have better water retention behavior. In comparison with the corresponding homopolymers, having comparable K values, copolymers having high K values have the advantage that they have less tendency to undesired gelling of the coating slips.

Usually, initiators which form free radicals under the reaction conditions are used in the polymerization. Suitable polymerization initiators are, for example, peroxides, hydroperoxides, hydrogen peroxide, sodium or potassium persulfate, redox catalysts and azo compounds, such as 2,2-azobis(N,N-dimethyleneisobutyramidine) dihydrochloride, 2,2-azobis(4-methoxy-2,4-dimethylvaleronitrile), 2,2-azobis(2,4-dimethylvaleronitrile) and 2,2-azobis(2-amidinopropane) dihydrochloride. The initiators are used in the amounts customary in the polymerization. Preferably used polymerization initiators are azo initiators. However, the polymerization can also be initiated with the aid of high-energy rays, such as electron beams, or by irradiation with UV light.

The aqueous dispersions of the water-soluble anionic polymers, which dispersions are used for the preparation of the paper coating slips, have a polymer concentration of anionic polymers of, for example, from 1 to 70% by weight or from 5 to 50% by weight, or from 10 to 25% by weight or from 15 to 20% by weight. Stable aqueous dispersions of anionic copolymers having a particle size of from 0.1 to 200 μm, preferably from 0.5 to 70 μm, are preferred. The particle size can be determined, for example, by optical microscopy, light scattering or freeze fracture electron microscopy.

Suitable neutralizing agents for the copolymers having acid groups are, for example, alkali metal, alkaline earth metal and/or amine bases. Particularly preferred neutralizing agents are sodium hydroxide solution, potassium hydroxide solution, ammonia, ethanolamine, diethanolamine or triethanolamine. In addition, all other amines or polyamines, such as diethylenetriamine, triethylenetetramine, polyethyleneimines and/or polyvinylamines, can be used as neutralizing agents. The amount of neutralizing agent which is used depends substantially on the desired viscosity which the paper coating slip is to have. This viscosity is dependent on the pH, which is preferably in the range from 6 to 10, in particular from 7 to 9.5.

### Polymeric Stabilizers

The preparation of the copolymers is effected in an aqueous medium in the presence of at least one polymeric stabilizer for water-in-water polymer dispersions. Preferred stabilizers are selected from water-soluble polymers of the following groups (a) and (b). The use of at least one water-soluble stabilizer of group (a) in combination with at least one water-soluble stabilizer of group (b) is particularly preferred, group a) consisting of
a1) graft polymers of vinyl acetate and/or vinyl propionate on (i) polyethylene glycols or (ii) polyethylene glycols or polypropylene glycols endcapped at one or both ends with alkyl, carboxyl or amino groups;
a2) polyalkylene glycols, in particular those having molar masses Mₙ of from 1000 to 100 000;
a3) polyalkylene glycols endcapped at one or both ends with alkyl, carboxyl or amino groups and having molar masses of Mₙ of preferably from 1000 to 100 000;
a4) copolymers of alkylpolyalkylene glycol acrylates or alkylpolyalkylene glycol methacrylates and acrylic acid and/or methacrylic acid;
   and group b) consisting of water-soluble copolymers of the group consisting of
b1) at least partly hydrolyzed copolymers of vinyl alkyl ethers and maleic anhydride, which can be present at least partly in the salt form neutralized, for example, with alkali metal hydroxides or ammonium bases;
b2) water-soluble starch (e.g. potato starch), in particular from the group consisting of cationically modified starch, anionically modified starch, degraded starch, e.g. thermally, oxidatively or enzymatically degraded starch, and maltodextrin;
b3) anionic homo- and copolymers selected from the group consisting of the
   homo- and copolymers of exclusively anionic monomers;
   copolymers of anionic and cationic and, if appropriate, neutral monomers, the proportion of the anionic monomers incorporated in the form of polymerized units being greater than that of the cationic monomers and
   copolymers of at least one anionic monomer and at least one monomer from the group consisting of the esters of anionic monomers with monohydric alcohols, styrene, N-vinylpyrrolidone, N-vinylcaprolactam, N-vinylimidazole, N-vinylformamide, acrylamide, methacrylamide, vinyl acetate and vinyl propionate;
   water-soluble or water-dispersible copolymers of (1) anionic monoethylenically unsaturated monomers and (2) nonionic monoethylenically unsaturated monomers, the proportion of the anionic monomers incorporated in the form of polymerized units being at least equal to that of the nonionic monomers;
b4) cationic copolymers of nonionic monoethylenically unsaturated monomers and cationic monoethylenically unsaturated monomers and, if appropriate, anionic monoethylenically unsaturated monomers, the number of cationic groups in any case being greater than the number of anionic groups.

The copolymers to be used according to the invention and present in the form of a dispersion are also designated below as “emulsion polymers according to the invention” or as “W/W polymers” or as “W/W emulsion polymers”. The polymers of groups a) and b) are also designated below as “stabilizers”. It is preferable if the W/W emulsion polymers and the polymers a) and polymers b) also designated as stabilizers are water-soluble. Water-soluble polymers are understood as meaning polymers which are soluble in an amount of at least 1 g in 1 liter of deionized water at 20° C. and atmospheric pressure to give a clear solution.

The polymerization is effected in an aqueous solution which is preferably free of neutral salts. The amount of polymeric stabilizers of group (a) is, for example, from 0.5 to 39.5% by weight or from 1 to 30% by weight or from 2 to 25% by weight, based on the total dispersion. The amount of polymeric stabilizers of group (b) is, for example, from 0.5 to 15 or from 1 to 12% by weight. The ratio of the components (a) and (b) in the stabilizer mixtures can be varied within a wide range. It may be, for example, from 1:10 to 50:1 or from 1:5 to 20:1 or from 1:4 to 15:1.

The aqueous dispersions have viscosities in the range from 200 to 100 000 mPa s, preferably from 200 to 20 000 mPa s, preferably from 200 to 10 000 mPa s (measured in a Brookfield viscometer at 20° C., spindle 6, 100 rpm), for example at a pH of 2.5.

### Polymers of Group a)

The stabilizers of group (a) include a1) graft polymers of vinyl acetate and/or vinyl propionate on (i) polyethylene glycols or (ii) polyethylene glycols or polypropylene glycols endcapped at one or both ends with alkyl, carboxyl or amino groups, copolymers of alkylpolyalkylene glycol (meth)acrylates and (meth)acrylic acid and also polyalkylene glycols and polyalkylene glycols encapped at one or both ends with alkyl, carboxyl or amino groups.

Polyalkylene glycols are described, for example, in WO 03/046024, page 4, line 37 to page 8, line 9. The polyalkylene glycols described therein can be used either directly as a stabilizer of group (a) or can be modified so that, for example, from 10 to 1000, preferably from 30 to 300, parts by weight of vinyl acetate and/or vinyl propionate are grafted onto 100 parts by weight of the polyalkylene glycols. Polyethylene glycol having a molecular weight MN of from 1000 to 100 000 is preferably used as the grafting base, and vinyl acetate is grafted thereon.

Other suitable stabilizers of group (a) are a4) copolymers of alkylpolyalkylene glycol acrylates or alkylpolyalkylene glycol methacrylates and acrylic acid and/or methacrylic acid. They are prepared by a procedure in which first adducts of ethylene oxide and/or propylene oxide with, for example, C₁- to C₁₈-alcohols are esterified with acrylic acid and/or methacrylic acid and these esters are then copolymerized with acrylic acid and/or methacrylic acid. The copolymers usually used comprise, for example, from 5 to 60, preferably from 10 to 35, % by weight of units of alkylpolyalkylene glycol (meth)acrylates incorporated in the form of copolymerized units and from 95 to 40, preferably from 90 to 65, % by weight of units of (meth)acrylic acid incorporated in the form of polymerized units. They generally have molar masses M_{W} of from 2000 to 50 000, preferably from 5000 to 20 000. These copolymers can be used in the form of the free acid groups or in completely or partly neutralized form in the preparation of the dispersions. The carboxyl groups of the copolymers are preferably neutralized with sodium hydroxide solution or ammonia.

The polyalkylene glycols a2) and the polyalkylene glycols a3) endcapped at one or both ends with alkyl, carboxyl or amino groups have, for example, molar masses Mₙ of from 100 to 100 000, preferably from 300 to 80 000 or from 600 to 50 000 or from 1000 to 50 000. Such polymers are described, for example, in the above-cited WO 03/046024, page 4, line 37 to page 8, line 9. Preferred polyalkylene glycols are, for example, polyethylene glycol, polypropylene glycol and block copolymers of ethylene oxide and propylene oxide. The block copolymers may comprise ethylene oxide and propylene oxide in any desired amounts and in any desired sequence, incorporated in the form of polymerized units. The terminal OH groups of the polyalkylene glycols can, if appropriate, be endcapped at one or both ends with alkyl, carboxyl or amino groups, a methyl group preferably being suitable as terminal group.

Particularly preferably used stabilizers of group a2) are copolymers of ethylene oxide and propylene oxide. Block copolymers of ethylene oxide and propylene oxide having a molar mass MN of 500 to 20 000 g/mol and a content of ethylene oxide units of from 10 to 80 mol % are particularly preferred. Particularly preferably used stabilizers of group a2) are three-block copolymers of the general formula (EO)ₓ(PO)_{y}(EO)_{z}, where x, y and z are numbers greater than zero. The terminal OH groups of these polyalkylene glycols can, if appropriate, be endcapped at one or both ends with alkyl, carboxyl or amino groups, a methyl group being preferred as a terminal group. The molar mass of preferred polyalkylene glycols is in the range from 300 to 20 000, preferably from 900 to 9000, g/mol, with a proportion of ethylene oxide in the range from 10 to 90% by weight. Such polyalkylene glycols are commercially available, for example, as Pluronic® brands. The Pluronic® PE brands are low-foaming, nonionic surfactants which are prepared by copolymerization of propylene oxide and ethylene oxide. As shown by the following general formula (I), the Pluronic® PE brands are block polymers in which polypropylene glycol forms the central molecular moiety:

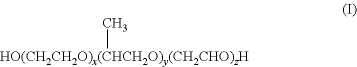

Particularly preferred are the Pluronic PE types, such as, for example, Pluronic® PE 3100, Pluronic® PE 3500, Pluronic® PE 4300, Pluronic® PE 6100, Pluronic® PE 6200, Pluronic® PE 6120, Pluronic® PE 6200, Pluronic® PE 6400, Pluronic® PE 7400, Pluronic® PE 8100, Pluronic® PE 9200, Pluronic® PE 9400, Pluronic® PE 10100, Pluronic® PE 10300, Pluronic® PE 10400, Pluronic® PE 10500, Pluronic® PE 10500 solution, Pluronic® PE 3500.

The following table gives an overview of the Pluronic® types suitable as a).

| | | Molar mass of | | Proportion of |
|---|---|---|---|---|
| | | the polypropylene | | polyethylene |
| | | glycol block | | glycol in the |
| Pluronic ® | Digit | (g/mol) | Digit | molecule (%) |
| PE 3100 | 3 | 850 | 1 | 10 |
| PE 3500 | 3 | 850 | 5 | 50 |
| PE 4300 | 4 | 1100 | 3 | 30 |
| PE 6100 | 6 | 1750 | 1 | 10 |
| PE 6120 | 6 | 1750 | 12 | 12 |
| PE 6200 | 6 | 1750 | 2 | 20 |
| PE 6400 | 6 | 1750 | 4 | 40 |
| PE 6800 | 6 | 1750 | 8 | 80 |
| PE 7400 | 7 | 2100 | 4 | 40 |
| PE 8100 | 8 | 2300 | 1 | 10 |
| PE 9200 | 9 | 2750 | 2 | 20 |
| PE 9400 | 9 | 2750 | 4 | 40 |
| PE 10100 | 10 | 3250 | 1 | 10 |
| PE 10300 | 10 | 3250 | 3 | 30 |
| PE 10400 | 10 | 3250 | 4 | 40 |
| PE 10500 | 10 | 3250 | 5 | 50 |

In a preferred embodiment of the invention, mixtures of abovementioned polyalkylene glycols are used as polymeric stabilizers a3). Preferred mixtures are, for example, mixtures of different Pluronic brands, the mixing weight ratio being in the range from 5:1 to 1:5, preferably in the range from 2:1 to 1:2 and in particular in the range from 1.3:1 to 1:1.3. Mixtures which comprise Pluronic®PE 4300 and Pluronic®PE 6200 or consist thereof are particularly suitable for the preparation of the W/W emulsion polymers for the use according to the invention.

The following are suitable as polymers of group (b):
b1) at least partly hydrolyzed copolymers of vinyl alkyl ethers and maleic anhydride, which may be present at least partly in the form of the alkali metal or ammonium salts. The alkyl group of the vinyl alkyl ethers preferably has 1 to 4 carbon atoms. The copolymers are obtainable by copolymerization of the vinyl alkyl ethers with maleic anhydride and subsequent partial or complete hydrolysis of the anhydride groups to give carboxyl groups and, if appropriate, partial or complete neutralization of the carboxyl groups with the formation of the salts.

Particularly preferred polymers of group b) are at least partly or completely hydrolyzed copolymers of vinyl methyl ether and maleic anhydride, which are present at least partly in the form of their alkali metal or ammonium salts.
b2) starches from the group consisting of cationically modified starch, anionically modified starch, degraded starch and maltodextrin. Starches can be obtained from beans, peas, barley, oats, millet, such as, for example, waxy millet, potatoes, corn, such as, for example, amylocorn or waxy corn, cassaya, rice, such as, for example, waxy rice, rye or wheat. Preferred starches are water-soluble starches, in particular water-soluble potato starches. Examples of cationically modified potato starches are the commercial products Amylofax®15 and Perlbond®970. A suitable anionically modified potato starch is Perfectamyl®A 4692. Here, the modification substantially comprises carboxylation of potato starch. C*Pur®1906 is an example of an enzymatically degraded potato starch and Maltodextrin C 01915 is an example of a hydrolytically degraded potato starch. Of the starches mentioned, Maltodextrin is preferably used.
b3) anionic copolymers selected from the group consisting of the
b3-1) homo- and copolymers comprising or consisting of anionic monomers,
b3-2) copolymers of anionic and cationic and, if appropriate, neutral monomers, the proportion of the anionic monomers incorporated in the form of polymerized units being greater than that of the cationic monomers and
b3-3) copolymers of at least one anionic monomer and at least one monomer from the group consisting of the esters of anionic monomers with monohydric alcohols, styrene, N-vinylpyrrolidone, N-vinylcaprolactam, N-vinylimidazole, N-vinylformamide, acrylamide, methacrylamide, vinyl acetate and vinyl propionate.

For example, at least one homopolymer of an ethylenically unsaturated C₃- to C₅-carboxylic acid, vinylsulfonic acid, styrenesulfonic acid, acrylamidomethylpropanesulfonic acid, vinylphosphonic acid, the salts thereof which are partially or completely neutralized with alkali metal and/or ammonium bases and/or at least one copolymer of these monomers are used as polymers of group (b3-1). Examples of ethylenically unsaturated carboxylic acids which are used for the preparation of the aqueous dispersions have already been mentioned. These anionic monomers can accordingly likewise be used for the preparation of the polymers (b) of the stabilizer mixtures. Acrylic acid, methacrylic acid, acrylamidomethylpropanesulfonic acid and mixtures of these monomers in any desired ratios are preferred for this purpose. Copolymers of methacrylic acid and acrylamidomethylpropanesulfonic acid are particularly suitable, in a preferred embodiment the molar ratio of the monomers methacrylic acid to acrylamidomethylpropanesulfonic acid used for the preparation of the copolymers being in the range from 9:1 to 1:9, preferably from 9:1 to 6:4.

Further suitable polymers of group (b3-2) of the stabilizer mixture are copolymers of
(i) at least one ethylenically unsaturated C₃- to C₅-carboxylic acid, vinylsulfonic acid, styrenesulfonic acid, acrylamidomethylpropanesulfonic acid, vinylphosphonic acid and/or the alkali metal and/or ammonium salts thereof,
(ii) at least one cationic monomer from the group consisting of partly or completely neutralized dialkylaminoalkyl(meth)acrylates, partly or completely quaternized dialkylaminoalkyl(meth)acrylates, dialkylaminoalkyl(meth)acrylamides in quaternized or neutralized form, dialkyldiallylammonium halides and quaternized N-vinylimidazole and, if appropriate,
(iii) at least one neutral monomer,
   the proportion of anionic monomers incorporated in the form of polymerized units being greater than that of the cationic monomers.

Examples of anionic monomers (i) have already been mentioned above. Suitable cationic monomers (ii) are, for example, dialkylaminoalkyl(meth)acrylates, such as dimethylaminoethyl acrylate, dimethylaminoethyl methacrylate, diethylaminoethyl acrylate, diethylaminoethyl methacrylate, dimethylaminopropyl acrylate, dimethylaminopropyl methacrylate, diethylaminopropyl acrylate and diethylaminopropyl methacrylate, dialkyldiallylammonium halides, such as dimethyldiallylammonium chloride and diethyldiallylammonium chloride, N-vinylimidazole, quaternized N-vinylimidazole and dialkylaminoalkylacrylamides, such as dimethylamino-ethylacrylamide or dimethylaminoethylmethacrylamide. Basic monomers, such as dimethylaminoethyl acrylate or dimethylaminoethyl methacrylate, can be used both in the form of the free bases and in a form partly or completely neutralized with acids, such as hydrochloric acid, sulfuric acid, formic acid and p-toluenesulfonic acid. The basic monomers can moreover be partly or completely quaternized by the reaction with C₁- to C₁₈-alkyl halides and/or C₁- to C₁₈-alkyl or C₁- to C₁₈-alkylaryl halides and can be used in this form in the polymerization. Examples of these are the dimethylaminoethyl (meth)acrylates completely quaternized with methyl chloride, such as dimethylaminoethyl acrylate methochloride or dimethylaminoethyl methacrylate methochloride. The polymers of group (b) may also comprise vinylamine units as cationic groups. Such polymers are obtainable, for example, by polymerizing N-vinylformamide, if appropriate together with at least one anionic water-soluble monomer, and then hydrolyzing the polymers with elimination of some of the formyl groups to give polymers comprising vinylamine units.

For example, the esters of anionic monomers, in particular of C₃- to C₅-carboxylic acids, and monohydric alcohols having 1 to 20 carbon atoms, such as, in particular, methyl acrylate, methyl methacrylate, ethyl acrylate, n-butyl, sec-butyl and tert-butyl acrylate, 2-ethylhexyl acrylate, ethyl methacrylate, isopropyl acrylate, isopropyl methacrylate and n-butyl, sec-butyl and tert-butyl methacrylate, and acrylamide, methacrylamide, acrylonitrile, methacrylonitrile, N-vinylpyrrolidone, N-vinylimidazole, N-vinylformamide, vinyl acetate, vinyl propionate and styrene, can be used as neutral monomers (iii).

In the case of the amphoteric copolymers suitable as component (b3-2), the proportion of the anionic monomers incorporated in the form of polymerized units is always greater than that of the cationic monomers. These copolymers therefore always carry an anionic charge.

Suitable copolymers of group (b3-3) are moreover copolymers of
(i) at least one anionic monomer and
(ii) at least one monomer from the group consisting of the esters of ethylenically unsaturated acids with monohydric alcohols, styrene, N-vinylpyrrolidone, N-vinylcaprolactam, N-vinylimidazole, N-vinylformamide, acrylamide, methacrylamide, vinyl acetate and vinyl propionate,
   for example copolymers of acrylic acid, methyl acrylate and N-vinylpyrrolidone or copolymers of methacrylic acid, acrylamidomethylpropanesulfonic acid, methyl acrylate and vinylimidazole.

The polymers (b3) may comprise the suitable monomers incorporated in the form of polymerized units in any desired ratios, only the amphoteric copolymers having a composition such that they always carry an anionic charge.
b4) cationic copolymers of nonionic monoethylenically unsaturated monomers and cationic monoethylenically unsaturated monomers and, if appropriate, anionic monoethylenically unsaturated monomers, the number of cationic groups being greater than the number of anionic groups.

For example, copolymers of
(b4-1) water-soluble, nonionic, monoethylenically unsaturated monomers,
(b4-2) water-soluble, cationic, monoethylenically unsaturated monomers and, if appropriate,
(b4-3) water-soluble, anionic, monoethylenically unsaturated monomers,
   are used as polymers of group (b4), the proportion of the cationic monomers incorporated in the form of polymerized units being greater than that of the anionic monomers.

Examples of water-soluble, nonionic monomers (b4-1) are acrylamide, methacrylamide, N-vinylformamide, N-vinylpyrrolidone and N-vinylcaprolactam. In principle, all nonionic, monoethylenically unsaturated monomers which have a water solubility of at least 100 g/l at a temperature of 20° C. are suitable as monomers of group (b4). Monomers (b1) which are miscible in any ratio with water and form clear aqueous solutions, such as acrylamide or N-vinylformamide, are particularly preferred.

Water-soluble, cationic, monoethylenically unsaturated monomers (b4-2) are, for example, dialkylaminoalkyl(meth)acrylates, such as dimethylaminoethyl acrylate, dimethylaminoethyl methacrylate, diethylaminoethyl acrylate, diethylaminoethyl methacrylate, dimethylaminopropyl acrylate, dimethylaminopropyl methacrylate, diethylaminopropyl acrylate and diethylaminopropyl methacrylate, dialkyldiallylammonium halides, such as dimethyldiallylammonium chloride and diethyldiallylammonium chloride, N-vinylimidazole and quaternized N-vinylimidazole. Basic monomers, such as dimethylaminoethyl acrylate or dimethylaminoethyl methacrylate, can be used both in the form of the free bases and in a form partly or completely neutralized with acids, such as hydrochloric acid, sulfuric acid, formic acid and p-toluenesulfonic acid. The basic monomers can moreover be partially or completely quarternized by reaction with C₁- to C₁₈-alkyl halides and/or C₁- to C₁₈-alkylaryl halides and can be used in this form in the polymerization. Examples of these are the dimethylaminoethyl(meth)acrylates completely quaternized with methyl chloride, such as dimethylaminoethyl acrylate methochloride or dimethylaminoethyl methacrylate methochloride. The polymers of group (b4) may also comprise vinylamine units as a cationic group. Such polymers are obtainable, for example, by polymerizing N-vinylformamide, if appropriate together with at least one anionic water-soluble monomer, and then hydrolyzing the polymers with elimination of some of the formyl groups to give polymers comprising vinylamine units.

The polymers of group (b4) can, if appropriate, also comprise at least one anionic monoethylenically unsaturated monomer (b4-3) incorporated in the form of polymerized units. Examples of such monomers are the anionic monomers which have already been mentioned above and form water-soluble polymers, such as, for example, acrylic acid, methacrylic acid, vinylsulfonic acid, vinylphosphonic acid, maleic acid, fumaric acid, crotonic acid, itaconic acid and the alkali metal and ammonium salts of these acids. Examples of copolymers of group (b4) are copolymers of
(b4-1) acrylamide, methacrylamide, N-vinylformamide, N-vinylpyrrolidone and/or N-vinylcaprolactam,
(b4-2) dialkylaminoalkyl acrylate, dialkylaminoalkyl methacrylate, partly or completely neutralized dialkylaminoalkyl(meth)acrylates, quaternized dialkylaminoalkyl (meth)acrylates, dialkyldiallylammonium halides, N-vinylimidazole and quaternized N-vinylimidazole and, if appropriate,
(b4-3) acrylic acid, methacrylic acid, vinylsulfonic acid, vinylphosphonic acid, maleic acid, fumaric acid, crotonic acid, itaconic acid and the alkali metal and ammonium salts of these acids.

The polymers (b4) comprise, for example,
(b4-1) from 2 to 90, preferably from 20 to 80 and particularly preferably 35 to 70 mol % of at least one nonionic monomer
(b4-2) from 2 to 90, preferably from 20 to 80 and particularly preferably from 35 to 70 mol % of at least one cationic monomer
   and
(b4-3) from 0 to 48.9 mol %, preferably from 0 to 30 and particularly preferably from 0 to 10 mol %, of at least one anionic monomer incorporated in the form of polymerized units, the proportion of the cationic monomer units being greater than that of the anionic monomer units.

Individual examples of polymers (b4) are copolymers of acrylamide and dimethylaminoethyl acrylate methochloride, copolymers of acrylamide and dimethylaminoethyl methacrylate methochloride, copolymers of acrylamide and dimethylaminopropyl acrylate methochloride, copolymers of methacrylamide and dimethylaminoethyl methacrylate methochloride, copolymers of acrylamide, dimethyl-aminoethyl acrylate methochloride and acrylic acid, copolymers of acrylamide, dimethylaminoethyl methacrylate methochloride and methacrylic acid and copolymers of acrylamide, dimethylaminoethyl acrylate methochloride and acrylic acid.

The polymers (b) can also be characterized with the aid of the K value. They have, for example, a K value of from 15 to 200, preferably from 30 to 150 and particularly preferably from 45 to 110 (determined according to H. Fikentscher, Cellulose-Chemie, volume 13, 58-64 and 71-74 (1932) in 3% strength by weight aqueous sodium chloride solution at 25° C., a polymer concentration of 0.1% by weight and a pH of 7). The average molar mass M_{w} of the polymers of group (b) of the stabilizer mixture is, for example, up to 1.5 million, or up to 1.2 million and is preferably in the range from 1000 to 1 million, or from 1500 to 100 000 or from 2000 to 70 000 (determined by the light scattering method).

In a preferred embodiment of the invention, the aqueous dispersions of the copolymers preferably comprise a combination of
(a2) at least one block copolymer of ethylene oxide and propylene oxide and
(b3) at least one copolymer selected from the group consisting of methacrylic acid and acrylamidomethylpropanesulfonic acid, a copolymer of methyl acrylate, acrylamidomethylpropanesulfonic acid and quaternized vinylimidazole having an overall anionic charge, a copolymer of acrylamidomethylpropanesulfonic acid, acrylic acid, methyl acrylate and styrene, polyacrylic acid, polymethacrylic acid and polyacrylamidomethylpropanesulfonic acid
   as a stabilizer.

In a preferred embodiment of the invention, the aqueous dispersions of the anionic polymers preferably comprise a combination of
(a1) at least one graft polymer of vinyl acetate on polyethylene glycols having a molecular weight MN of from 1000 to 100 000 and
(b1) at least one at least partly hydrolyzed copolymer of vinyl alkyl ether, preferably vinyl methyl ether, and maleic anhydride, which may be present at least partially in salt form, for example as the sodium, potassium or ammonium salt,
   as a stabilizer.

In a further preferred embodiment of the invention, the following combination of polymers is used:
(a4) copolymers of alkylpolyalkylene glycol acrylates or alkylpolyalkylene glycol methacrylates and acrylic acid and/or methacrylic acid and
(b1) at least one hydrolyzed copolymer of vinyl methyl ether and maleic anhydride in the form of the free carboxyl groups and at least partly in the form of the salts formed, for example, with sodium hydroxide, potassium hydroxide or ammonia.

Further combinations of stabilizers for the preparation of the aqueous dispersions of anionic polymers are, for example, mixtures of
(a2,a3) polypropylene glycols, polyethylene glycols and/or block copolymers of ethylene oxide and propylene oxide having molecular weights MN of from 300 to 50 000 and/or having C₁- to C₄-alkyl groups, polypropylene glycols, polyethylene glycols and/or block copolymers of ethylene oxide and propylene oxide having a molecular weight MN of from 300 to 50 000, which are endcapped at one or both ends, and
(b2) maltodextrin.

In a further preferred embodiment of the invention, the aqueous dispersions of the anionic polymers preferably comprise a combination of
(a2) at least one block copolymer of ethylene oxide and propylene oxide and
(b4) at least one copolymer of acrylamide and dimethylaminoethyl acrylate methochloride
   as a stabilizer.

The copolymer (b4) can, if appropriate, also comprise up to 5 mol % of acrylic acid incorporated in the form of polymerized units.

An embodiment of the invention is a paper coating slip which comprises, based on an aqueous medium:
(i) from 80 to 95 parts by weight of inorganic pigments, based on the total solids content, at least one calcium carbonate pigment being present in an amount of from 50 to 100 parts by weight, based on the total amount of pigments, and
(ii) from 0.05 to 5 parts by weight, based on the total amount of pigments, of at least one copolymer in the form of an aqueous dispersion of water-soluble copolymers, obtainable by free-radical polymerization of at least one first monomer type and at least one second monomer type in the presence of at least one first polymeric stabilizer and at least one second polymeric stabilizer,
   the first monomer type being selected from the group consisting of acrylic acid and methacrylic acid and the second monomer type being selected from the group consisting of acrylates of monohydric alcohols having 1 to 20 carbon atoms and methacrylates of monohydric alcohols having 1 to 20 carbon atoms, and
   the first polymeric stabilizer being selected from the group consisting of polyethylene glycol and polyethylene glycol/polypropylene glycol block copolymers and the second polymeric stabilizer being selected from the group consisting of at least partly hydrolyzed copolymers of vinyl alkyl ethers and maleic anhydride and copolymers of methacrylic acid and acrylamidoalkanesulfonic acid.

### Binder

The paper coating slip usually comprises at least one binder. The most important functions of binders in paper coating slips are to bind the pigments to the paper and the pigments to one another and partly to fill voids between pigment particles. The amount of the binders is preferably from 1 to 50 parts by weight or from 1 to 20 parts by weight per 100 parts by weight of pigment or filler (solid, i.e. without water or other solvents liquid at 21° C., 1 bar).

Suitable binders are those having a natural basis, in particular starch-based binders and synthetic binders, in particular emulsion polymers which can be prepared by emulsion polymerization. Starch-based binders are to be understood in this context as meaning any native, modified or degraded starch. Native starches may consist of amylose, amylopectin or mixtures thereof. Modified starches may be oxidized starch, starch esters or starch ethers. The molecular weight of the starch can be reduced by hydrolysis (degraded starch). Suitable degradation products are oligosaccharides or dextrins. Preferred starches are cereal, corn and potato starch. Cereal and corn starch are particularly preferred and cereal starch is very particularly preferred.

Emulsion polymers which are suitable as synthetic binders and are usually used preferably comprise at least 40% by weight, preferably at least 60% by weight, particularly preferably at least 80% by weight, of so-called main monomers. The main monomers are selected from C₁-C₂₀-alkyl(meth)acrylates, vinyl esters of carboxylic acids comprising up to 20 carbon atoms, vinylaromatics having up to 20 carbon atoms, ethylenically unsaturated nitriles, vinyl halides, vinyl ethers of alcohols comprising 1 to 10 carbon atoms, aliphatic hydrocarbons having 2 to 8 carbon atoms and one or two double bonds or mixtures of these monomers. For example, alkyl(meth)acrylates having a C₁-C₁₀-alkyl radical, such as methyl methacrylate, methyl acrylate, n-butyl acrylate, ethyl acrylate and 2-ethylhexyl acrylate, may be mentioned. In particular, mixtures of alkyl(meth)acrylates are also suitable. Vinyl esters of carboxylic acids having 1 to 20 carbon atoms are, for example, vinyl laurate, vinyl stearate, vinyl propionate, vinyl versatate and vinyl acetate. Suitable vinylaromatic compounds are vinyltoluene, α- and p-methylstyrene, α-butylstyrene, 4-n-butylstyrene, 4-n-decyl-styrene and preferably styrene. Examples of nitriles are acrylonitrile and methacrylonitrile. The vinyl halides are ethylenically unsaturated compounds substituted by chlorine, fluorine or bromine, preferably vinyl chloride and vinylidene chloride. For example vinyl methyl ether or vinyl isobutyl ether may be mentioned as vinyl ethers. Vinyl ethers of alcohols comprising 1 to 4 carbon atoms are preferred. Ethylene, propylene, butadiene, isoprene and chloroprene may be mentioned as hydrocarbons having 2 to 8 carbon atoms and one or two olefinic double bonds.

Preferred main monomers are C₁-C₁₀-alkyl(meth)acrylates and mixtures of the alkyl (meth)acrylates with vinylaromatics, in particular styrene, or hydrocarbons having 2 double bonds, in particular butadiene, or mixtures of such hydrocarbons with vinylaromatics, in particular styrene. In the case of mixtures of aliphatic hydrocarbons (in particular butadiene) with vinylaromatics (in particular styrene), the ratio may be, for example, from 10:90 to 90:10, in particular 20:80 to 80:20. Particularly preferred main monomers are butadiene and the above mixtures of butadiene and styrene.

In addition to the main monomers, the emulsion polymer suitable as binder may comprise further monomers, for example monomers having carboxyl, sulfo or phosphonic acid groups. Carboxyl groups are preferred. For example, acrylic acid, methacrylic acid, itaconic acid, maleic acid or fumaric acid may be mentioned. The content of ethylenically unsaturated acids in the emulsion polymer is in general less than 5% by weight. Further monomers are, for example, also monomers comprising hydroxyl groups, in particular C₁-C₁₀-hydroxyalkyl(meth)acrylates, or amides, such as (meth)acrylamide.

With the use of synthetic binders, natural binders, such as starch, may also be concomitantly used but are not absolutely essential.

Paper coating slips according to the invention may additionally comprise further additives and assistants, e.g. fillers, cobinders and further thickeners for further optimization of viscosity and water retention, optical brighteners, dispersants, surfactants, lubricants (e.g. calcium stearate and waxes), neutralizing agents (e.g. NaOH or ammonium hydroxide) for pH adjustment, antifoams, deaerating agents, preservatives (e.g. biocides), leveling agents, dyes, etc. Suitable further thickeners in addition to synthetic polymers (e.g. crosslinked polyacrylate) are in particular celluloses, preferably carboxymethylcellulose. Optical brighteners are, for example, fluorescent or phosphorescent dyes, in particular stilbenes.

It is preferably an aqueous paper coating slip; it comprises water, in particular due to the formulation of the constituents (aqueous polymer dispersions, aqueous pigment slurries); the desired viscosity can be established by addition of further water. Customary solids contents of the paper coating slips are in the range from 30 to 70% by weight. The pH of the paper coating slip is preferably adjusted to values of from 6 to 10, in particular from 7 to 9.5.

### Preparation and Use

The preparation of the paper coating slip can be effected by customary methods. The constituents are combined and mixed in the customary manner. The paper coating slip is preferably applied to uncoated base papers or uncoated cardboard. The amount is in general from 1 to 50 g, preferably from 5 to 30 g (solid, i.e. without water or other solvents which are liquid at 21° C., 1 bar) per square meter. The coating can be effected by customary application methods, e.g. by means of a size press, film press, blade coater, airbrush, knife coater, curtain coating or spray coater. Depending on the pigment system, the aqueous dispersions of the water-soluble copolymers can be used in paper coating slips for the basecoat and/or for the top coat. In an embodiment of the invention, a paper coating slip comprising carbonate pigments as the sole pigments in combination with the aqueous dispersions of the water-soluble copolymers, if appropriate in combination with further assistants and additives, is applied as the basecoat to paper or cardboard.

The invention also relates to a method for coating paper or cardboard,
an aqueous dispersion of at least one water-soluble copolymer being provided, the copolymer being obtainable by free-radical polymerization of at least one first monomer type and at least one second monomer type in the presence of at least one polymeric stabilizer, the first monomer type comprising ethylenically unsaturated, anionic monomers capable of free-radical polymerization and the second monomer type comprising ethylenically unsaturated, nonionic monomers capable of free-radical polymerization; and
a coating slip being prepared with the aqueous dispersion, at least one metal salt pigment, at least one binder, water and optional further assistants; and
the coating slip being applied to paper or cardboard

The coating slip preferably comprises at least one carbonate pigment; in particular, it comprises exclusively carbonate pigments, e.g. calcium carbonate, as pigments. The coating slip is preferably applied as a basecoat, i.e. as the first or only coating, to paper or cardboard.

The paper coating slips according to the invention have a low water retention and a reduced tendency to gelling. The coated papers and cardboards have good performance characteristics, in particular high gloss and good pick resistance. They are readily printable in the customary printing processes, such as relief printing, gravure printing, offset printing, digital printing, inkjet printing, flexographic printing, newspaper printing, letterpress printing, sublimation printing, laser printing, electrophotographic printing or a combination of these printing processes.

### EXAMPLES

Aqueous polymer dispersions are prepared by free-radical polymerization in water. The reactions are carried out under inert conditions (supply of nitrogen for 30 min before the reaction, constant supply of nitrogen during the reaction). Unless stated otherwise, the stirring speed is 200 rpm. The viscosity of the emulsions prepared is determined using a Brookfield viscometer. K values are determined according to Fikentscher For the determination, the polymers are dissolved to a concentration of 0.1% in a 5% NaCl solution. Unless stated otherwise, the solutions are aqueous solutions.

### Example 1

The polymerization is effected with the following substances:
481.4 g of demineralized water
271.4 g of a 35% strength aqueous solution of a copolymer of maleic acid and vinyl methyl ether
30 g of polyethylene glycol (M=1500 g/mol),
180 g of acrylic acid,
20 g of ethyl acrylate
17 g of sodium hypophosphite
0.2 g of 2,2′-azobis(2-amidinopropane) dihydrochloride
0.2 g of 2,2′-azobis[N,N′-dimethyleneisobutyramidine]dihydrochloride

Water, the solution of the copolymer of maleic acid and vinyl methyl ether, polyethylene glycol, the monomers and sodium hypophosphite are weighed into a 2 l vessel having a stirrer and reflux condenser and are heated to 40° C. 2,2′-Azobis(2-amidinopropane) dihydrochloride is then added. After six hours, 2,2′-azobis[N,N′-dimethylene-isobutyramidine]dihydrochloride is added and the temperature is increased to 50° C. After a further two hours, the reaction is complete.

A white emulsion is obtained. The K value is 48.0.

### Example 2

The polymerization is effected with the following substances:
498.4 g of demineralized water
271.4 g of a 35% aqueous solution of a copolymer of maleic acid and vinyl methyl ether
30 g of polyethylene glycol (M=1500 g/mol)
180 g of acrylic acid
20 g of ethyl acrylate
2,2′-azobis[N,N′-dimethyleneisobutyramidine]dihydrochloride

Water, the solution of the copolymer of maleic acid and vinyl methyl ether and polyethylene glycol are heated to 40° C. in a 2 l vessel having a stirrer and reflux condenser. 0.2 g of 2,2′-azobis[N,N′-dimethyleneisobutyramidine]dihydrochloride is then added. In the course of 10 min, the monomer mixture is added dropwise. After six hours, 0.2 g of 2,2′-azobis[N,N′-dimethyleneisobutyramidine]dihydrochloride is added and the temperature is increased to 50° C. After a further two hours, the reaction is complete.

A white emulsion is obtained.
Viscosity: 22000 mPa s (spindle 4, 10 rpm)
K value: 177.3

### Example 3

The polymerization is effected with the following substances:
498.4 g of demineralized water
271.4 g of a 35% aqueous solution of a copolymer of maleic acid and vinyl methyl ether
30 g of polyethylene glycol (M=1500 g/mol)
90 g of acrylic acid
90 g methacrylic acid
20 g of ethyl acrylate
2,2′-azobis(2-amidinopropane) dihydrochloride

Water, the solution of the copolymer of maleic acid and vinyl methyl ether and polyethylene glycol are heated to 60° C. in a 2 l vessel having a stirrer and reflux condenser. 0.2 g of 2,2′-azobis(2-amidinopropane) dihydrochloride is then added. In the course of 10 min, the monomer mixture is added dropwise. After six hours, 0.2 g of 2,2′-azobis(2-amidinopropane) dihydrochloride is added. After a further two hours, the reaction is complete.

A white emulsion is obtained.
Particle size: from 10 to 20 μm.
Viscosity: 10600 mPa s (spindle 4, 5 rpm)
K value: 148.5

### Example 4

The polymerization is effected with the following substances:
473.8 g of demineralized water
146 g of a 10.5% aqueous solution of a copolymer of methacrylic acid and acrylamido-2-methylpropanesulfonic acid
180 g of (EO/PO/EO) three-block copolymer (Pluronic® PE4300)
180 g of acrylic acid
20 g of ethyl acrylate
2,2′-azobis[N,N′-dimethyleneisobutyramidine]dihydrochloride

Water, the solution of the copolymer of methacrylic acid and acrylamido-2-methylpropanesulfonic acid and three-block copolymer are heated to 40° C. in a 2 l vessel having a stirrer and reflux condenser. 0.2 g of 2,2′-azobis[N,N′-dimethylene-isobutyramidine]dihydrochloride is then added. In the course of 10 min, the monomer mixture is added dropwise. After six hours, 0.1 g of 2,2′-azobis[N,N′-dimethylene-isobutyramidine]dihydrochloride is added. After a further two hours, the reaction is complete.

A white emulsion is obtained.
Particle size: from 10 to 20 μm.
Viscosity: 10600 mPa s (spindle 4, 5 rpm)
K value: 148.5

### Example 5

The polymerization is effected with the following substances:
400 g of demineralized water
25 g of Lupasol® S, 20% strength aqueous solution (poly(acrylic acid-co-acrylamido-2-methylpropanesulfonic acid-co-methyl acrylate-co-styrene)
200 g of Lupasol® S, 5% strength aqueous solution of poly(acrylic acid-co-acrylamido-2-methylpropanesulfonic acid-co-methyl acrylate-co-styrene)
125 g of (EO/PO/EO) three-block copolymer (Pluronic® PE3500)
180 g of acrylic acid
20 g of ethyl acrylate

50 g 1% strength aqueous sodium peroxodisulfate solution

Water, 20% strength Lupasol® S and the three-block copolymer are heated to 60° C. in a 2 l vessel having a stirrer and reflux condenser. Sodium peroxodisulfate solution, the monomer mixture and 5% strength Lupasol® S are then simultaneously added dropwise in the course of six hours. After a further 105 minutes, the reaction is complete.

A white emulsion is obtained.
Viscosity: 1700 mPa s (spindle 4, 20 rpm)
K value: 76.7

### Example 6

The polymerization is effected with the following substances:
575 g of demineralized water
50 g of Lupasol® S, 20% strength aqueous solution (poly(acrylic acid-co-acrylamido-2-methylpropanesulfonic acid-co-methyl acrylate-co-styrene)
125 g of (EO/PO/EO) three-block copolymer (Pluronic® PE3500)
180 g of acrylic acid
20 g of ethyl acrylate
50 g 1% strength aqueous sodium peroxodisulfate solution

275 g of water, Lupasol® S and the three-block copolymer are heated to 60° C. in a 2 l vessel having a stirrer and reflux condenser. Sodium peroxodisulfate solution, the monomer mixture and 300 g of water are then simultaneously added dropwise in the course of six hours. After a further 105 minutes, the reaction is complete.

A white emulsion is obtained.
Viscosity: 1300 mPa s (spindle 4, 20 rpm)
K value: 82.7

### Example 7

The polymerization is effected with the following substances:
575 g of demineralized water
50 g of Lupasol® S, 20% strength aqueous solution (poly(acrylic acid-co-acrylamido-2-methylpropanesulfonic acid-co-methyl acrylate-co-styrene)
125 g of (EO/PO/EO) three-block copolymer (Pluronic® PE3500)
180 g of acrylic acid
20 g of ethyl acrylate
50 g a 2% strength aqueous solution of 2,2′-azobis(2-amidinopropane) dihydrochloride

Water, Lupasol® S and the three-block copolymer are heated to 60° C. in a 2 l vessel having a stirrer and reflux condenser. Initiator solution and the monomer mixture are then simultaneously added dropwise in the course of six hours. After a further 105 minutes, the reaction is complete.

A white emulsion is obtained.
Viscosity: 1140 mPa s (spindle 4, 20 rpm)
K value: 65.8

### Example 8

The polymerization is effected with the following substances:
572.7 g of demineralized water
50 g of Lupasol® S, 20% strength aqueous solution (poly(acrylic acid-co-acrylamido-2-methylpropanesulfonic acid-co-methyl acrylate-co-styrene)
125 g of (EO/PO/EO) three-block copolymer (Pluronic® PE3500)
180 g of acrylic acid
20 g of ethyl acrylate
50 g of 0.5% strength aqueous sodium peroxodisulfate solution
3.3 g of PLEX 6954-O (60% strength aqueous solution of an ethoxylated (25 EO) C₁₆-G₁₈-fatty alcohol methacrylic acid ester)

275 g of water, Lupasol® S and the three-block copolymer are heated to 60° C. in a 2 l vessel having a stirrer and reflux condenser. Sodium peroxodisulfate solution, the monomer mixture, PLEX 6954-O and 296.7 g of water are then simultaneously added dropwise in the course of six hours. After a further 105 min, the reaction is complete.

A white emulsion is obtained.
Viscosity: 1350 mPa s (spindle 4, 20 rpm)
K value: 116.4

### Example 9

The polymerization is effected with the following substances:
625 g of demineralized water
50 g of Lupasol® S, 20% strength aqueous solution (poly(acrylic acid-co-acrylamido-2-methylpropanesulfonic acid-co-methyl acrylate-co-styrene)
125 g of (EO/PO/EO) three-block copolymer (Pluronic® PE3500)
180 g of acrylic acid
20 g of ethyl acrylate
0.2 g of sodium peroxodisulfate

Water, Lupasol® S and the three-block copolymer are heated to 40° C. in a 2 l vessel having a stirrer and reflux condenser. The initiator is then added. The monomer mixture is then added dropwise in the course of 10 minutes. After a further two hours, the reaction is complete.

A white emulsion is obtained.
Particle size from 5 to 10 μm
Viscosity: 7950 mPa s (spindle 4, 10 rpm)
K value: 155.8

### Comparative Example C1

The polymerization is effected with the following substances:
498.4 g of demineralized water
271.4 g of a 35% aqueous solution of a copolymer of maleic acid and vinyl methyl ether
30 g of polyethylene glycol (M=1500 g/mol)
200 g of acrylic acid
2,2′-azobis[N,N′-dimethyleneisobutyramidine]dihydrochloride

Water, the solution of the copolymer of maleic acid and vinyl methyl ether, monomer and polyethylene glycol are heated to 40° C. in a 2 l vessel having a stirrer and reflux condenser. 0.2 g of 2,2′-azobis[N,N′-dimethyleneisobutyramidine]dihydrochloride is then added. After six hours, a further 0.2 g of 2,2′-azobis[N,N′-dimethylene-isobutyramidine]dihydrochloride is added and the temperature is increased to 50° C. After a further two hours, the reaction is complete.

A white emulsion is obtained.
Particle size from 3 to 8 μm
Viscosity: 10800 mPa s (spindle 4, 10 rpm)
K value: 155.6

### Comparative Example C2

The polymerization is effected as in comparative example C1 with the following substances:
498.4 g of demineralized water
271.4 g of a 35% aqueous solution of a copolymer of maleic acid and vinyl methyl ether
30 g of polyethylene glycol (M=1500 g/mol)
200 g of acrylic acid
0.25 g of pentaerythrityl triallyl ether
2,2′-azobis[N,N′-dimethyleneisobutyram idine]dihydrochloride
   A white emulsion is obtained.
   Particle size from 3 to 8 μm
   Viscosity: 17800 mPa s (spindle 4, 10 rpm)
   K value: cannot be determined (crosslinked polymer, undissolved fractions)

### Gelling Behavior

The gelling behavior was assessed visually by allowing a covered sample to stand overnight at 20-23° C. An ungelled sample is still flowable. A gelled sample is no longer flowable if the sample vessel is tilted. Furthermore, a gelled sample can be scored with a glass rod without the tear closing again. The gelled sample is like a pudding.

### Water Retention

The water retention (WR) was measured by the GRADEK method. The method characterizes a coating slip with regard to its water retention in a standardized laboratory test. Good water retention is very important for processing a paper coating slip on large and high-speed paper coating units. The coating slip to be tested is dewatered over a polycarbonate membrane into a filter paper layer under defined conditions (pressure of 1 bar, measuring time 1 minute). The amount of water taken up by the filter paper layer is determined gravimetrically. The more water which was taken up, the poorer is the water retention of the paper coating slip. The amount of water taken up is stated in g/m². Since deviations in the measured results may occur with the use of different batches of membrane filters, a comparison of different coating slips is carried out in each case with membrane filters of the same batch.

Apparatuses and materials used:

Pressure filtration apparatus Abo Akademi Gravimetric Water Retention,
balance, with which it is possible to weigh to 0.1 mg,
polycarbonate membrane filter, from Piper, pore size 5 μm, diameter 47 mm,
Schwarzband filter paper, Schleicher & Schüll diameter 9 cm, stopwatch

### Paper Coating Slips

Viscosities of the paper coating slips are measured using a Brookfield viscometer at 100 revolutions per minute and spindle No. 2, 15 minutes after the preparation of the coating slip.

### Example 10

Paper coating slips are prepared by stirring the
following aqueous constituents:

| | |
|---|---|
| 50 parts solid | Capim NP 50 (alumina pigment) |
| 50 parts solid | Covercarb 60 ME slurry (calcium carbonate pigment) |
| 10 parts solid | Styronal ® D628 (commercially available binder for |
| | paper coating slips, emulsion polymer based on |
| | butadiene, styrene and acrylonitrile) |
| 0.1-0.6 part solid | thickener according to any of Examples 1 to 9 or of |
| | Comparative Examples C1 to C4. |

The dose of the thickeners is chosen such that the Brookfield viscosity of the coating slip is about 800-900 mPa s. The pH of the coating slip is adjusted to 9.1-9.2 with NaOH solution and the solids content is adjuted to 67% with demineralized water.

| | | Amount of | | | |
|---|---|---|---|---|---|
| | | thickener | | | |
| | | (parts by | | Water | |
| | | weight, | Viscosity | retention | |
| Example | Thickener | solid) | (mPa s) | (g/m²) | Gelling |
| 10-2 | copolymer | 0.12 | 890 | 52 | little |
| | from Example | | | | |
| | 2; K 177 | | | | |
| 10-C1 | homopolymer | 0.12 | 920 | 54 | pronounced |
| | from Example | | | | |
| | C1; K 156 | | | | |
| 10-C2 | crosslinked | 0.12 | 790 | 57 | pronounced |
| | polymer from | | | | |
| | Example C2 | | | | |

### Example 11

Paper coating slips for the basecoat are prepared by stirring the following aqueous constituents:

| | |
|---|---|
| 100 parts solid | Hydrocarb ME 60 (natural ground calcium |
| | carbonate pigment, GCC) |
| 10 parts solid | Styronal ® D628 (commercially available |
| | binder for paper coating slips, emulsion |
| | polymer based on butadiene, styrene and |
| | acrylonitrile) |
| 0.1-1.6 part solid | thickener according to any of Examples 1 to 9 |
| | or of Comparative Examples C1 to C4. |

The dose of the thickeners is chosen such that the Brookfield viscosity of the coating slip is about 1200 mPa s. The pH of the coating slip is adjusted to 9.1-9.2 with NaOH solution and the solids content is adjusted to 65% with demineralized water.

| | | Amount of | | |
|---|---|---|---|---|
| | | thickener | | Water |
| Exam- | | (parts by | Viscosity | retention |
| ple | Thickener | weight, solid) | (mPa s) | (g/m²) |
| 11-1 | copolymer from | 1.24 | 1130 | 52 |
| | Example 5 | | | |
| 11-2 | copolymer from | 1.3 | 1120 | 54 |
| | Example 6 | | | |
| 11-3 | copolymer from | 1.1 | 1130 | 57 |
| | Example 7 | | | |
| 11-C1 | Sterocoll ® FS ¹⁾ | 0.33 | 1150 | 70 |

¹⁾ commercially available thickener, aqueous dispersion of an acrylate/(meth)acrylic acid copolymer, BASF

### Example 12

Paper coating slips for the basecoat are prepared by stirring the following aqueous constituents:

| | |
|---|---|
| 100 parts solid | Hydrocarb ME 60 (natural ground calcium |
| | carbonate pigment, GCC) |
| 10 parts solid | Styronal ® D628 (commercially available |
| | binder for paper coating slips, emulsion |
| | polymer based on butadiene, styrene and |
| | acrylonitrile) |
| 0.1-1.6 parts solid | thickener according to any of Examples 1 to 9 |
| | or of Comparative Examples C1 to C4. |

The dose of the thickeners is chosen so that the Brookfield viscosity of the coating slip is about 1200 mPa s. The pH of the coating slip is adjusted to 9.1-9.2 with NaOH solution and the solids content is adjusted to 65% with demineralized water.

| | | Amount of | | |
|---|---|---|---|---|
| | | thickener | | Water |
| | | (parts by | Viscosity | retention |
| Example | Thickener | weight, solid) | (mPa s) | (g/m²) |
| 12-1 | copolymer from | 0.53 | 1180 | 62 |
| | Example 8 | | | |
| 12-2 | copolymer from | 0.41 | 1380 | 55 |
| | Example 8 | | | |
| 12-3 | copolymer from | 0.9 | 1210 | 53 |
| | Example 9 | | | |
| 12-C1 | Sterocoll ® FS ¹⁾ | 0.38 | 1120 | 80 |

¹⁾ commercially available thickener, aqueous dispersion of an acrylate/(meth)acrylic acid-copolymer, BASF

### Example 13

Paper coating slips for the topcoat are prepared by stirring the following aqueous constituents:

| | |
|---|---|
| 60 parts solid | Hydrocarb 90 ME slurry (calcium carbonate |
| | pigment, GCC) |
| 40 parts solid | Hydragloss 90 slurry (alumina pigment) |
| 10 parts solid | Styronal ® D628 (commercially available |
| | binder for paper coating slips, emulsion |
| | polymer based on butadiene, styrene and |
| | acrylonitrile) |
| 0.1-0.6 part solid | thickener according to any of Examples 1 to 9. |

The dose of the thickeners is chosen so that the Brookfield viscosity of the coating slip is about 1200 mPa s. The pH of the coating slip is adjusted to 9.1-9.2 with NaOH solution and the solids content is adjusted to 67% with demineralized water.

### Comparative Example 14

Paper coating slips for gravure printing are prepared by stirring the following aqueous constituents:

| | |
|---|---|
| 50 parts solid | Talcum C10 Slurry (talc pigment) |
| 50 parts solid | Century Clay Slurry (alumina pigment) |
| 10 parts solid | Styronal ® D628 (commercially available |
| | binder for paper coating slips, emulsion |
| | polymer based on butadiene, styrene and |
| | acrylonitrile) |
| 0.1-0.6 parts solid | thickener according to any of Examples 1 to 9. |

The dose of the thickeners is chosen so that the Brookfield viscosity of the coating slip is about 1000 mPa s. The pH of the coating slip is adjusted to 9.1-9.2 with NaOH solution and the solids content is adjusted to 52% with demineralized water.

1. A paper coating slip, comprising
(i) at least one inorganic pigment, wherein at least one metal salt pigment is present in an amount of at least 40 parts by weight, based on a total amount of pigments and
(ii) an aqueous dispersion of at least one water-soluble copolymer obtained by free-radical polymerization of at least one first monomer and at least one second monomer in the presence of at least one polymeric stabilizer for water-in-water polymer dispersions,
wherein the first monomer comprises an ethylenically unsaturated, anionic monomer capable of free-radical polymerization and the second monomer comprises an ethylenically unsaturated, nonionic monomer capable of free-radical polymerization.

2. The paper coating slip according to claim 1, wherein the at least one polymeric stabilizer is at least one water-soluble polymer
selected from the group consisting of
a1) a graft polymer of vinyl acetate and/or vinyl propionate on (i) a polyethylene glycol or (ii) a polyethylene glycol or polypropylene glycol endcapped at one or both ends with an alkyl, carboxyl, or amino group;
a2) a polyalkylene glycol;
a3) a polyalkylene glycol endcapped at one or both ends with an alkyl, carboxyl, or amino group;
a4) a copolymer of an alkylpolyalkylene glycol acrylate or alkylpolyalkylene glycol methacrylate and acrylic acid and/or methacrylic acid;
b1) an at least partly hydrolyzed copolymer of a vinyl alkyl ether and maleic anhydride, which can be present at least partly in a salt form;
b2) a water-soluble starch;
b3) an anionic homo- and copolymer selected from the group consisting of
a homopolymer of at least one anionic monomer
a copolymer of exclusively anionic monomers;
a copolymer of an anionic and a cationic and, optionally, a neutral monomer, wherein a proportion of polymerized anionic monomers incorporated is greater than that of the cationic monomers and
a copolymer of at least one anionic monomer and at least one monomer selected from the group consisting of an ester of an anionic monomer with a monohydric alcohol, styrene, N-vinylpyrrolidone, N-vinylcaprolactam, N-vinylimidazole, N-vinylformamide, acrylamide, methacrylamide, vinyl acetate, and vinyl propionate;
a water-soluble or water-dispersible copolymer of (1) at least one anionic monoethylenically unsaturated monomer and (2) at least one nonionic monoethylenically unsaturated monomer, wherein a proportion of polymerized anionic monomers incorporated into the water-soluble or water-dispersible copolymer is at least equal to that of polymerized nonionic monomers; and
b4) a cationic copolymer of at least one nonionic monoethylenically unsaturated monomer and at least one cationic monoethylenically unsaturated monomer and, optionally, at least one anionic monoethylenically unsaturated monomer, with a number of cationic groups being greater than a number of anionic groups.

3. The paper coating slip according to claim 1, wherein the polymerization is effected in the presence of at least one first polymeric stabilizer and at least one second polymeric stabilizer differing from the at least one first polymeric stabilizer, wherein the first stabilizer is selected from the group consisting of:
a1) a graft polymer of vinyl acetate and/or vinyl propionate on (i) a polyethylene glycol or (ii) a polyethylene glycol or polypropylene glycol endcapped at one or both ends with an alkyl, carboxyl, or amino group;
a2) a polyalkylene glycol;
a3) a polyalkylene glycol endcapped at one or both ends with an alkyl, carboxyl, or amino group; and
a4) a copolymer of an alkylpolyalkylene glycol acrylate or alkylpolyalkylene glycol methacrylate and acrylic acid and/or methacrylic acid; and
the second stabilizer is selected from the group consisting of:
b1) an at least partly hydrolyzed copolymer of a vinyl alkyl ether and maleic anhydride, which can be present at least partly in a salt form;
b2) a water-soluble starch;
b3) an anionic homo- and copolymer selected from the group consisting of
a homopolymer of at least one anionic monomer
copolymer of exclusively anionic monomers;
a copolymer of an anionic and a cationic and, optionally, a neutral monomer, wherein a proportion of polymerized anionic monomers incorporated is greater than that of the cationic monomers and
a copolymer of at least one anionic monomer and at least one monomer selected from the group consisting of an ester of an anionic monomer with a monohydric alcohol, styrene, N-vinylpyrrolidone, N-vinylcaprolactam, N-vinylimidazole, N-vinylformamide, acrylamide, methacrylamide, vinyl acetate, and vinyl propionate;
a water-soluble or water-dispersible copolymer of (1) at least one anionic monoethylenically unsaturated monomer and (2) at least one nonionic monoethylenically unsaturated monomer, wherein a proportion of polymerized anionic monomers incorporated is at least equal to that of nonionic monomers; and
b4) a cationic copolymer of at least one nonionic monoethylenically unsaturated monomer and at least one cationic monoethylenically unsaturated monomer and, optionally, at least one anionic monoethylenically unsaturated monomer, with a number of cationic groups being greater than a number of anionic groups.

4. The paper coating slip according to claim 1, wherein the at least one metal salt pigment is selected from the group consisting of calcium sulfate, calcium aluminate sulfate, barium sulfate, magnesium carbonate, and calcium carbonate.

5. The paper coating slip according to claim 1, wherein the amount of the at least one metal salt pigment is from 50 to 100% by weight, based on the total amount of pigments.

6. The paper coating slip according to claim 1, wherein a further inorganic pigment selected from the group consisting of a silicic acid, an aluminum oxide, hydrated alumina, a silicate, titanium dioxide, zinc oxide, kaolin, alumina, talc, and silicon dioxide, is present in addition to the at least one metal salt pigment.

7. The paper coating slip according to claim 1, wherein the first monomer of the at least one copolymer is at least one selected from the group consisting of a monoethylenically unsaturated C₃- to C₅-carboxylic acid, vinylsulfonic acid, styrenesulfonic acid, acrylamidomethylpropanesulfonic acid, vinylphosphonic acid, an alkali metal salt of a monoethylenically unsaturated C₃- to C₅-carboxylic acid, an alkali metal salt of vinylsulfonic acid, an alkali metal salt of styrenesulfonic acid, an alkali metal salt of acrylamidomethylpropanesulfonic acid, an alkali metal salt of vinylphosphonic acid, an ammonium salt of a monoethylenically unsaturated C₃- to C₅-carboxylic acid, an ammonium salt of vinylsulfonic acid, an ammonium salt of styrenesulfonic acid, an ammonium salt of acrylamidomethylpropanesulfonic acid, and an ammonium salt of vinylphosphonic acid.

8. The paper coating slip according to claim 1, wherein the second monomer of the at least one copolymer is at least one selected from the group consisting of acrylamide, methacrylamide, an acrylate of a monohydric alcohol having 1 to 20 carbon atoms, a methacrylate of a monohydric alcohol having 1 to 20 carbon atoms, vinyl acetate, and vinyl propionate.

9. The paper coating slip according to claim 1, wherein a weight ratio of first monomer to second monomer of the at least one copolymer is from 95:5 to 60:40.

10. The paper coating slip according to claim 1, wherein an amount of copolymer in the paper coating slip is from 0.05 to 5 parts by weight per 100 parts by weight of pigment.

11. The paper coating slip according to claim 1, wherein the copolymer is a copolymer of acrylic acid with at least one comonomer selected from the group consisting of an acrylate of a monohydric alcohol having 1 to 20 carbon atoms and a methacrylate of a monohydric alcohol having 1 to 20 carbon atoms.

12. The paper coating slip according to claim 1, wherein the copolymer has a K value of at least 60.

13. The paper coating slip according to claim 1, further comprising at least one assistant selected from the group consisting of a polymeric binder, a cobinder, an optical brightener, a filler, a leveling agent, a dispersant, a surfactant, a lubricant, a neutralizing agent, an antifoam, a deaerating agent, a preservative, and a dye.

14. The paper coating slip according to claim 13, wherein the polymeric binder is present in an amount of from 1 to 50 parts by weight, based on the total amount of pigments, and the polymeric binder is selected from the group consisting of a starch-comprising binder and an emulsion polymer comprising at least 40% by weight of at least one main monomer selected from the group consisting of a C₁-C₂₀-alkyl(meth)acrylate, a vinyl ester of a carboxylic acid comprising up to 20 carbon atoms, a vinylaromatic having up to 20 carbon atoms, an ethylenically unsaturated nitrile, a vinyl halide, a vinyl ether of an alcohol comprising 1 to 10 carbon atoms, an aliphatic hydrocarbon having 2 to 8 carbon atoms and one double bond, and an aliphatic hydrocarbon having 2 to 8 carbon atoms and two double bonds.

15. The paper coating slip according to claim 1, which comprises, based on an aqueous medium,
(i) from 80 to 95 parts by weight of at least one inorganic pigment, based on a total solids content, wherein at least one calcium carbonate pigment in an amount of from 50 to 100 parts by weight, based on the total amount of pigments, is present, and
(ii) from 0.05 to 5 parts by weight, based on the total amount of pigments, of at least one copolymer in the form of an aqueous dispersion of at least one water-soluble copolymer obtained by free-radical polymerization of at least one first monomer and at least one second monomer in the presence of at least one first polymeric stabilizer and at least one second polymeric stabilizer, wherein
the first monomer is selected from the group consisting of acrylic acid, and methacrylic acid and the second monomer is selected from the group consisting of an acrylate of a monohydric alcohol having 1 to 20 carbon atoms and a methacrylate of a monohydric alcohol having 1 to 20 carbon atoms, and
the at least one first polymeric stabilizer is selected from the group consisting of polyethylene glycol and a polyethylene glycol/polypropylene glycol block copolymer, and the at least one second polymeric stabilizer is selected from the group consisting of an at least partly hydrolyzed copolymer of a vinyl alkyl ether and maleic anhydride and a copolymer of methacrylic acid and acrylamidoalkanesulfonic acid.

16. The paper coating slip according to claim 1, wherein the at least one water-soluble copolymer present in the aqueous dispersion is not crosslinked.

17. A method of manufacturing a paper coating slip, the method comprising combining an aqueous dispersion of at least one water-soluble copolymer with the paper coating slip composition comprising at least one metal salt pigment,
wherein the at least one copolymer is obtained by free-radical polymerization of at least one first monomer and at least one second monomer type in the presence of at least one polymeric stabilizer,
the at least one first monomer comprises at least ethylenically unsaturated, anionic monomer capable of free radical polymerization, and
the at least one second monomer comprises at least one ethylenically unsaturated, nonionic monomer capable of free radical polymerization.

18. A method of manufacturing a coated paper or cardboard, the method comprising contacting a base paper or cardboard with the paper coating slip according to claim 1.

19. A paper or cardboard coated with the paper coating slip according to claim 1.

20. A method for coating paper or cardboard,
preparing a coating slip by combining at least one metal salt pigment, at least one binder, water, optionally, at least one further assistant, and an aqueous dispersion of at least one water-soluble copolymer obtained by free radical polymerization of at least one first monomer and at least one second monomer in the presence of at least one polymeric stabilizer, wherein the first monomer comprises at least one ethylenically unsaturated, anionic monomer capable of free radical polymerization and the second monomer comprises at least one ethylenically unsaturated, nonionic monomer capable of free radical polymerization; and
the coating slip being prepared with the aqueous dispersion, at least one metal salt pigment, at least one binder, water and optional further assistants; and applying the coating slip being applied to a base paper or cardboard.
